(19) United States
(12) Patent Application Publication
(10) Pub. No.: US 2026/0017774 A1
(43) Pub. Date: Jan. 15, 2026

(54) IMAGE RECONSTRUCTION VERIFICATION FOR SEMICONDUCTOR EXAMINATION

(71) Applicant: Applied Materials Israel Ltd., Rehovot (IL)

(72) Inventors: Nati OFIR, Rehovot (IL); Uri Israel ZACKHEM, Kfar Saba (IL); Ran BADANES, Rishon Le-Zion (IL); Boris SHERMAN, Rehovot (IL)

(21) Appl. No.: 18/773,430

(22) Filed: Jul. 15, 2024

(51) Int. Cl. G06T 7/00

(52) U.S. Cl. CPC G06T 7/0008; G06T 7/001; G06T 2207/30148; G06T 2207/30168

(57) ABSTRACT

There is provided a system and method of examining a semiconductor specimen. The method includes obtaining an input image of the semiconductor specimen; processing the input image using a first machine learning (ML) model, to obtain a synthetic image corresponding to the input image, where the synthetic image is reconstructed to resemble a target image pertaining to the specific application; processing, by a second ML model, the synthetic image and one of the input image or the target image of the synthetic image, to obtain a defect map indicative of defect distribution in the input image or the target image with respect to the synthetic image; and verifying quality of the synthetic image based on the defect map. The first ML model is previously trained for image reconstruction for a specific application, and the second ML model is previously trained for defect detection.

### TECHNICAL FIELD

The presently disclosed subject matter relates, in general, to the field of examination of a semiconductor specimen, and more specifically, to machine-learning based image reconstruction for examination of a specimen.

### BACKGROUND

Current demands for high density and performance associated with ultra large-scale integration of fabricated devices require submicron features, increased transistor and circuit speeds, and improved reliability. As semiconductor processes progress, pattern dimensions such as line width, and other types of critical dimensions, are continuously shrunken. Such demands require formation of device features with high precision and uniformity, which, in turn, necessitates careful monitoring of the fabrication process, including automated examination of the devices while they are still in the form of semiconductor wafers.

Examination can be provided by using non-destructive examination tools during or after manufacture of the specimen to be examined. A variety of non-destructive examination tools includes, by way of non-limiting example, scanning electron microscopes, atomic force microscopes, optical inspection tools, etc.

Examination processes can include a plurality of examination steps. The manufacturing process of a semiconductor device can include various procedures such as etching, depositing, planarization, growth such as epitaxial growth, implantation, etc. The examination steps can be performed a multiplicity of times, for example after certain process procedures, and/or after the manufacturing of certain layers, or the like. Additionally, or alternatively, each examination step can be repeated multiple times, for example for different wafer locations, or for the same wafer locations with different examination settings.

During the examination processes at various steps during semiconductor fabrication, examination images are acquired by the examination tools which are processed for purpose of examination operations such as detecting and classifying defects on specimens, as well as performing metrology related operations.

Effectiveness of examination can be improved by automatization of process(es) such as, for example, defect detection, Automatic Defect Classification (ADC), Automatic Defect Review (ADR), image segmentation, automated metrology-related operations, etc. Automated examination systems ensure that the parts manufactured meet the quality standards expected and provide useful information on adjustments that may be needed to the manufacturing tools, equipment, and/or compositions, depending on the type of defects identified. In some cases, machine learning (ML) technologies can be used to assist the automated examination process so as to promote higher yield.

### SUMMARY

In accordance with certain aspects of the presently disclosed subject matter, there is provided a computerized system of examining a semiconductor specimen, the system comprising a processing circuitry configured to obtain an input image of the semiconductor specimen; process the input image using a first machine learning (ML) model, to obtain a synthetic image corresponding to the input image, wherein the first ML model is previously trained for image reconstruction for a specific application, and the synthetic image is reconstructed to resemble a target image pertaining to the specific application; process, by a second ML model, the synthetic image and one of the input image or the target image of the synthetic image, to obtain a defect map indicative of defect distribution in the input image or the target image with respect to the synthetic image, wherein the second ML model is previously trained for defect detection; and verify quality of the synthetic image based on the defect map.

In addition to the above features, the system according to this aspect of the presently disclosed subject matter can comprise one or more of features (i) to (x) listed below, in any desired combination or permutation which is technically possible:
(i). The processing circuitry is configured to verify the quality of the synthetic image by comparing the defect map with ground truth defect information of the input image or the target image, and verifying, based on the comparison, whether an unexpected defect is present in the synthetic image during image reconstruction.
(ii). The processing circuitry is further configured to provide a verification result indicative of presence of the unexpected defect in the synthetic image, use the verification result to prepare a refined training set, and retrain the first ML model using the refined training set.
(iii). The ground truth defect information is obtained based on manual annotation, or a defect detection algorithm.
(iv). The unexpected defect represents one of: an original defect in the input image that was supposed to be removed during image reconstruction, or an artificial defect that was introduced during image reconstruction.
(v) The specific application is reference generation, where the input image is an original image of the semiconductor specimen acquired by an examination tool, and the synthetic image is a reconstructed reference image that is expected to be defect-free and usable for comparison with the original image.
   The processing circuitry is configured to process, by the second ML model, the synthetic image and the input image to obtain a defect map indicative of defect distribution in the input image with respect to the synthetic image.
(vi). The specific application is image enhancement, where the input image is a low-quality image of the semiconductor specimen, the synthetic image is a reconstructed high-quality image usable for examining the semiconductor specimen instead of using the low-quality image, and the target image is an actual high-quality image acquired by an examination tool.
   The processing circuitry is configured to process, using the second ML model, the synthetic image and the target image to obtain a defect map indicative of defect distribution in the target image with respect to the synthetic image.
(vii). The specific application is image simulation, where the input image is a design image of the semiconductor specimen, and the synthetic image is a simulated image resembling the target image which is an actual image of the specimen acquired by an examination tool.
   The processing circuitry is configured to process, using the second ML model, the synthetic image and the target image to obtain a defect map indicative of defect distribution in the target image with respect to the synthetic image.
(viii). The first ML model is previously trained under supervised learning using a training set comprising one or more pairs of training images, each pair including a training image and a corresponding ground truth image with respect to the specific application.
(ix). The second ML model is previously trained using a training set comprising one or more pairs of training images, each pair including an input training image and a corresponding reference image, the input training image associated with ground truth defect information thereof.
(x). The second ML model is trained prior to, or together with training of the first ML model, comprising: for each input training image in the training set, processing the input training image by the second ML model to obtain a predicted defect map, and optimizing the second ML model using a loss function to minimize a difference between the predicted defect map and the ground truth defect information of the input training image.

In accordance with other aspects of the presently disclosed subject matter, there is provided a computerized method of examining a semiconductor specimen, the method comprising: obtaining an input image of the semiconductor specimen; processing the input image using a first machine learning (ML) model, to obtain a synthetic image corresponding to the input image, wherein the first ML model is previously trained for image reconstruction for a specific application, and the synthetic image is reconstructed to resemble a target image pertaining to the specific application; processing, by a second ML model, the synthetic image and one of the input image or the target image of the synthetic image, to obtain a defect map indicative of defect distribution in the input image or the target image with respect to the synthetic image, wherein the second ML model is previously trained for defect detection; and verifying quality of the synthetic image based on the defect map.

These aspects of the disclosed subject matter can comprise one or more of features (i) to (x) listed above with respect to the system, mutatis mutandis, in any desired combination or permutation which is technically possible.

In accordance with other aspects of the presently disclosed subject matter, there is provided a non-transitory computer readable medium comprising instructions that, when executed by a computer, cause the computer to perform a method of examining a semiconductor specimen, the method comprising obtaining an input image of the semiconductor specimen; processing the input image using a first machine learning (ML) model, to obtain a synthetic image corresponding to the input image, wherein the first ML model is previously trained for image reconstruction for a specific application, and the synthetic image is reconstructed to resemble a target image pertaining to the specific application; processing, by a second ML model, the synthetic image and one of the input image or the target image of the synthetic image, to obtain a defect map indicative of defect distribution in the input image or the target image with respect to the synthetic image, wherein the second ML model is previously trained for defect detection; and verifying quality of the synthetic image based on the defect map.

These aspects of the disclosed subject matter can comprise one or more of features (i) to (x) listed above with respect to the system, mutatis mutandis, in any desired combination or permutation which is technically possible.

### BRIEF DESCRIPTION OF THE DRAWINGS

In order to understand the disclosure and to see how it may be carried out in practice, embodiments will now be described, by way of non-limiting example only, with reference to the accompanying drawings, in which:

FIG. 1 illustrates a generalized block diagram of an examination system in accordance with certain embodiments of the presently disclosed subject matter.

FIG. 2 illustrates a generalized flowchart of monitoring/verifying quality of reconstructed images in accordance with certain embodiments of the presently disclosed subject matter.

FIG. 3 illustrates a generalized flowchart of verifying the quality of the synthetic image in accordance with certain embodiments of the presently disclosed subject matter.

FIG. 4 illustrates a generalized flowchart of applying the verification process in a reference generation application in accordance with certain embodiments of the presently disclosed subject matter.

FIG. 5 illustrates a generalized flowchart of applying the verification process in an image enhancement application in accordance with certain embodiments of the presently disclosed subject matter.

FIG. 6 illustrates a generalized flowchart of applying the verification process in an image simulation application in accordance with certain embodiments of the presently disclosed subject matter.

FIG. 7 shows a schematic illustration of an exemplary training process of the first ML model in accordance with certain embodiments of the presently disclosed subject matter.

FIG. 8 shows a schematic illustration of an exemplary runtime examination process using a trained first ML model in accordance with certain embodiments of the presently disclosed subject matter.

FIG. 9 shows a schematic illustration of an exemplary training process of the second ML model in accordance with certain embodiments of the presently disclosed subject matter.

FIG. 10 illustrates examples of unexpected defects in accordance with certain embodiments of the presently disclosed subject matter.

FIG. 11 shows a schematic illustration of a runtime verification process as described above with reference to FIG. 2 in accordance with certain embodiments of the presently disclosed subject matter.

### DETAILED DESCRIPTION OF EMBODIMENTS

The process of semiconductor manufacturing often requires multiple sequential processing steps and/or layers, some of which could possibly cause errors that may lead to yield loss. Examples of various processing steps can include lithography, etching, depositing, planarization, growth (such as, e.g., epitaxial growth), and implantation, etc. Various examination operations, such as defect-related examination (e.g., defect detection, defect review, and defect classification, etc.), and/or metrology-related examination (e.g., critical dimension (CD) measurements, etc.), can be performed at different processing steps/layers during the manufacturing process to monitor and control the process. The examination operations can be performed a multiplicity of times, for example after certain processing steps, and/or after the manufacturing of certain layers, or the like.

Defect-related examination can generally employ a two-phase procedure, e.g., inspection of a specimen, followed by review of sampled locations of potential defects. During the first phase, the surface of a specimen is inspected by an inspection tool at relatively higher speed and lower resolution. Defect detection is typically performed by applying a defect detection algorithm to the inspection output. Various detection algorithms can be used for detecting defects on specimens, such as Die-to-Die (D2D), Die-to-History (D2H), Die-to-Database (D2DB), Cell-to-Cell (C2C), etc.

By way of example, a classic die-to-reference (D2R) detection algorithm, such as, e.g., Die-to-Die (D2D), is typically used in some cases. In D2D, an inspection image of a target die is captured. For purpose of detecting defects in the inspection image, one or more reference images are captured from one or more reference dies (e.g., one or more neighboring dies) of the target die. For instance, each die on the wafer can be compared with its adjacent dies, e.g., the preceding die and the subsequent die. The inspection image and the reference images are aligned and compared to each other. One or more difference images (and/or derivatives thereof, such as grade images) can be generated based on the difference between pixel values of the inspection image, and pixel values derived from the reference images. A detection threshold can then be applied to the difference maps, and a defect map is produced to show suspected locations on the target die having a high probability of being a true defect (also referred to as a defect of interest (DOI)).

During the second phase, at least some of the suspected locations on the defect map are more thoroughly analyzed by a review tool with relatively higher resolution, for ascertaining whether a defect candidate is indeed a DOI, and/or determining different parameters of the DOIs, such as classes, thickness, roughness, size, and so on. The D2R methodology as described above can be similarly applied during the second phase, such as, e.g., in automatic defect review (ADR) systems.

However, certain disadvantages are present with respect to the above-described D2R detection methods. For example, the D2D method requires the acquisition of at least two images (i.e., in cases of one inspection image and one reference image) which doubles the image acquisition time of the inspection tool. In cases of using multiple references, it significantly increases the image acquisition time in accordance with the number of reference images. In addition, prior to comparison, the inspection image and reference images need to be registered. In some cases, they need additional pre-processing in order to compensate for noises representing the variations (such as, e.g., process variation and color variations) between the two images. These unavoidably increase the processing time of the detection methods, thus affect detection throughput (TpT). In addition, the detection sensitivity may also be affected due to the residual variations and noises which were not eliminated by the pre-processing.

In some cases, ML based image reconstruction techniques can be used to generate a synthetic reference image, which can be used to compare with an inspection image, instead of additional acquisition of an actual reference image. However, the quality and reliability of these synthetic images remain uncertain. Despite thorough training, neural networks may exhibit unpredictable behavior, leading to the introduction of artificial artifacts and variations. Moreover, defects that should be removed may not be completely eliminated, while non-existent defects may be introduced. This unpredictability can result in synthetic images that do not accurately reflect the true characteristics of the target image, thus compromising the defect detection process.

Such a challenge is not only present in defect detection applications, but rather extends to other examination applications where ML-based image reconstruction techniques are employed. For instance, generating high-resolution images from low-resolution ones, or creating SEM images from design data, face similar issues. The network's behavior can lead to inconsistencies, reducing the reliability of the reconstructed images.

Ensuring the accuracy and reliability of these synthetic images is paramount, as they directly impact the subsequent specimen examination and analysis processes. By way of example, relying on synthetic images without verification can lead to unexpected errors in the defect detection process. False positives and false negatives can compromise the reliability of the inspection, leading to potential failures in the final product and affecting yield.

Traditionally, the quality of these synthetic images is verified manually, which is both time-consuming and prone to errors. Human verification not only increases the inspection time, but also introduces the possibility of subjective judgment errors, reducing the overall reliability and efficiency of the defect detection process.

Accordingly, certain embodiments of the presently disclosed subject matter address the inherent uncertainties in synthetic image generation and propose a robust framework for continuously monitoring/verifying the quality of synthetic images, ensuring that the ML-based image reconstruction techniques produce reliable and accurate images. Specifically, the present disclosure proposes to use a first machine learning (ML) model to generate a synthetic image corresponding to an input image, and use a second ML model to process the synthetic image reconstructed by the first ML model and corresponding input or target images to generate a defect map. By comparing the defect map with ground truth defect information, the quality of the synthetic images can be verified, ensuring that the first ML model does not introduce artificial defects, or fails to remove existing defects during image reconstruction, as will be detailed below.

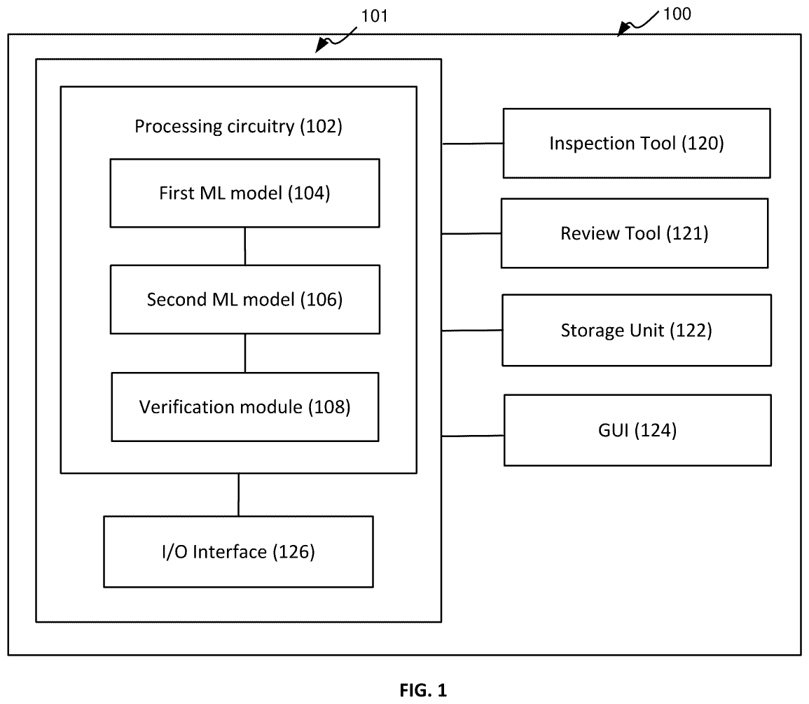

Bearing this in mind, attention is drawn to FIG. 1 illustrating a functional block diagram of an examination system in accordance with certain embodiments of the presently disclosed subject matter.

The examination system 100 illustrated in FIG. 1 can be used for examination of a semiconductor specimen (e.g., a wafer, a die, or parts thereof) as part of the specimen fabrication process. As described above, the examination referred to herein can be construed to cover any kind of operations related to defect inspection/detection, defect review, defect classification, nuisance filtration, segmentation, and/or metrology operations, such as, e.g., critical dimension (CD) measurements, etc., with respect to the specimen. System 100 comprises one or more examination tools configured to scan a specimen and capture images thereof to be further processed for various examination applications.

The term “examination tool(s)” used herein should be expansively construed to cover any tools that can be used in examination-related processes, including, by way of non-limiting example, scanning (in a single or in multiple scans), imaging, sampling, reviewing, measuring, classifying, and/or other processes provided with regard to the specimen or parts thereof. Without limiting the scope of the disclosure in any way, it should also be noted that the examination tools can be implemented as inspection machines of various types, such as optical inspection machines, electron beam inspection machines (e.g., a Scanning Electron Microscope (SEM), an Atomic Force Microscopy (AFM), or a Transmission Electron Microscope (TEM), etc.), and so on.

The one or more examination tools can include one or more inspection tools 120 and one or more review tools 121. In some cases, an inspection tool 120 can be configured to scan a specimen (e.g., an entire wafer, an entire die, or portions thereof) to capture inspection images (typically, at a relatively high-speed and/or low-resolution) for detection of potential defects (i.e., defect candidates). During inspection, the wafer can move at a step size relative to the detector of the inspection tool (or the wafer and the tool can move in opposite directions relative to each other) during the exposure, and the wafer can be scanned step-by-step along swaths of the wafer by the inspection tool, where the inspection tool images a part/portion (within a swath) of the specimen at a time. By way of example, the inspection tool can be an optical inspection tool. At each step, light can be detected from a rectangular portion of the wafer and such detected light is converted into multiple intensity values at multiple points in the portion, thereby forming an image corresponding to the part/portion of the wafer. For instance, in optical inspection, an array of parallel laser beams can scan the surface of a wafer along the swaths. The swaths are laid down in parallel rows/columns contiguous to one another, to build up, swath-at-a-time, an image of the surface of the wafer. For instance, the tool can scan a wafer along a swath from up to down, then switch to the next swath and scan it from down to up, and so on and so forth, until the entire wafer is scanned and inspection images of the wafer are collected.

In some cases, a review tool 121 can be configured to capture review images of at least some of the defect candidates detected by inspection tools for ascertaining whether a defect candidate is indeed a defect of interest (DOI). Such a review tool is usually configured to inspect fragments of a specimen, one at a time (typically, at a relatively low-speed and/or high-resolution). By way of example, the review tool can be an electron beam tool, such as, e.g., a scanning electron microscope (SEM), etc. An SEM is a type of electron microscope that produces images of a specimen by scanning the specimen with a focused beam of electrons. The electrons interact with atoms in the specimen, producing various signals that contain information on the surface topography and/or composition of the specimen. An SEM is capable of accurately inspecting and measuring features during the manufacture of semiconductor wafers.

The inspection tool 120 and review tool 121 can be different tools located at the same or at different locations, or a single tool operated in two different modes. In some cases, the same examination tool can provide low-resolution image data and high-resolution image data. The resulting image data (low-resolution image data and/or high-resolution image data) can be transmitted—directly or via one or more intermediate systems—to system 101. The present disclosure is not limited to any specific type of examination tools and/or the resolution of image data resulting from the examination tools. In some cases, at least one of the examination tools has metrology capabilities and can be configured to capture images and perform metrology operations on the captured images. Such an examination tool is also referred to as a metrology tool.

According to certain embodiments of the presently disclosed subject matter, the examination system 100 comprises a computer-based system 101 operatively connected to the inspection tool 120 and the review tool 121, and is capable of automatically monitoring/verifying quality of synthetic images generated by ML based image reconstruction techniques. System 101 is also referred to as an image reconstruction monitoring system, or verification system.

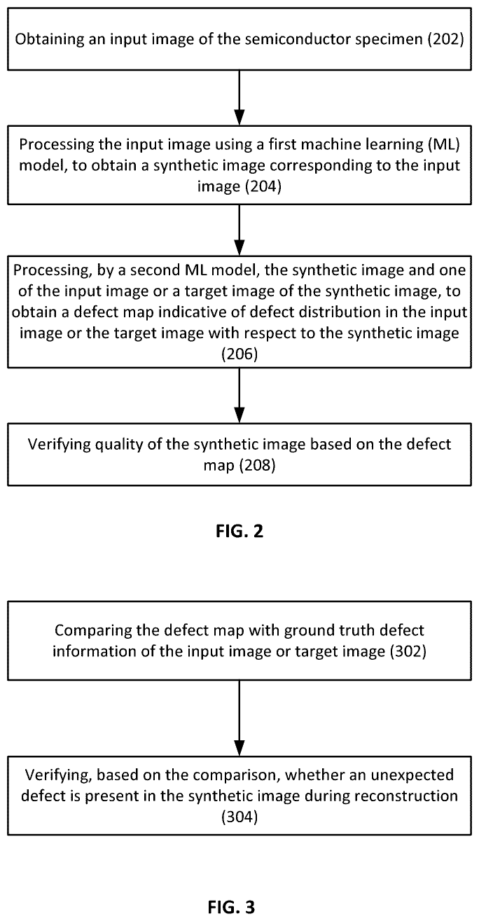

System 101 includes a processing circuitry 102 operatively connected to a hardware-based I/O interface 126 and configured to provide processing necessary for operating the system, as further detailed with reference to FIGS. 2-6. The processing circuitry 102 can comprise one or more processors (not shown separately) and one or more memories (not shown separately). The one or more processors of the processing circuitry 102 can be configured to, either separately or in any appropriate combination, execute several functional modules in accordance with computer-readable instructions implemented on a non-transitory computer-readable memory comprised in the processing circuitry. Such functional modules are referred to hereinafter as comprised in the processing circuitry.

According to certain embodiments, one or more functional modules comprised in the processing circuitry 102 of system 101 can include a first ML model 104, a second ML model 106, and a verification module 108 operatively connected to each other. The first ML model 104 and the second ML model 106 are previously trained during a training/setup phase.

Specifically, the processing circuitry 102 can be configured to obtain, via an I/O interface 126, an input image of a semiconductor specimen, and process the input image using the first ML model 104, to obtain a synthetic image corresponding to the input image. The first ML model is previously trained for image reconstruction for a specific application. The synthetic image is reconstructed to resemble a target image pertaining to the specific application.

The processing circuitry 102 can be configured to process, by the second ML model 106, the synthetic image and one of the input image or a target image of the synthetic image, to obtain a defect map indicative of defect distribution in the input image or the target image with respect to the synthetic image. The second ML model is previously trained for defect detection. The verification module 108 can be configured to verify quality of the synthetic image based on the defect map.

In some cases, the first ML model 104, the second ML model 106 and the verification module 108 can be regarded as part of an examination recipe usable for performing runtime examination operations for semiconductor specimens, including defect detection/review, image enhancement, image simulation, etc., on various input images, such as acquired runtime images and design images of a specimen.

In some embodiments, system 101 can be configured as a training system capable of training the first ML model 104 and/or the second ML model 106 during a training/setup phase. In such cases, one or more functional modules comprised in the processing circuitry 102 of system 101 can include a training module (not illustrated in the figure), and the first ML model 104 and the second ML model 106 to be trained (i.e., models that are not yet trained). Specifically, the training module can be configured to obtain a respective training set, and use the training set to train the first or the second model, as will be detailed below.

According to certain embodiments, the first ML model and/or the second ML model can be implemented as various types of machine learning models, such as, e.g., decision tree, Support Vector Machine (SVM), Artificial Neural Network (ANN), regression model, Bayesian network, or ensembles/combinations thereof etc. The learning algorithms used by the ML models can be any of the following: supervised learning, unsupervised learning, self-supervised, semi-supervised learning, or a combination thereof, etc. The presently disclosed subject matter is not limited to the specific types of the ML models or the specific types of learning algorithms used by the ML models.

By way of example, in some cases, the ML models can be implemented as a deep neural network (DNN). DNN can comprise multiple layers organized in accordance with respective DNN architecture. By way of non-limiting example, the layers of DNN can be organized in accordance with architecture of a Convolutional Neural Network (CNN), Recurrent Neural Network, Recursive Neural Networks, autoencoder, Generative Adversarial Network (GAN), or otherwise. Optionally, at least some of the layers can be organized into a plurality of DNN sub-networks. Each layer of DNN can include multiple basic computational elements (CE), typically referred to in the art as dimensions, neurons, or nodes.

The weighting and/or threshold values associated with the CEs of a DNN and the connections thereof can be initially selected prior to training, and can be further iteratively adjusted or modified during training to achieve an optimal set of weighting and/or threshold values in a trained DNN. After each iteration, a difference can be determined between the actual output produced by DNN module and the target output associated with the respective training set of data. The difference can be referred to as an error value. Training can be determined to be complete when a loss/cost function indicative of the error value is less than a predetermined value, or when a limited change in performance between iterations is achieved. A set of input data used to adjust the weights/thresholds of a DNN is referred to as a training set.

It is noted that the teachings of the presently disclosed subject matter are not bound by specific architecture of the ML models as described above.

It is to be noted that while certain embodiments of the present disclosure refer to the processing circuitry 102 being configured to perform the above recited operations, the functionalities/operations of the aforementioned functional modules can be performed by the one or more processors in processing circuitry 102 in various ways. By way of example, the operations of each functional module can be performed by a specific processor, or by a combination of processors. The operations of the various functional modules, such as the ML model processing, and quality verification, etc., can thus be performed by respective processors (or processor combinations) in the processing circuitry 102, while, optionally, these operations may be performed by the same processor. The present disclosure should not be limited to being construed as one single processor always performing all the operations.

In some cases, additionally to system 101, the examination system 100 can comprise one or more examination modules, such as, e.g., defect detection module, nuisance filtration module, Automatic Defect Review Module (ADR), Automatic Defect Classification Module (ADC), metrology operation module, and/or other examination modules which are usable for examination of a semiconductor specimen. The one or more examination modules can be implemented as stand-alone computers, or their functionalities (or at least part thereof) can be integrated with the examination tools 120 and 121. In some cases, the output of system 101, e.g., the verification result, and the verified synthetic images, can be provided to the one or more examination modules (such as the ADR, ADC, etc.) for further processing. In some cases, the functional modules 104, 106, and 108 can be comprised in the one or more examination modules for purpose of image reconstruction and verification. Optionally, these functional modules can be shared between the examination modules or, alternatively, each of the one or more examination modules can comprise its own functional modules.

According to certain embodiments, system 100 can comprise a storage unit 122. The storage unit 122 can be configured to store any data necessary for operating system 101, e.g., data related to input and output of system 101, as well as intermediate processing results generated by system 101. By way of example, the storage unit 122 can be configured to store images of the specimen and/or derivatives thereof produced by the examination tool 120, such as, e.g., the input images, synthetic images, and the training set, as described above. Accordingly, the different types of input data as required can be retrieved from the storage unit 122 and provided to the processing circuitry 102 for further processing. The output of the system 101, such as, e.g., the verification result, the verified synthetic images, etc., can be sent to storage unit 122 to be stored.

In some embodiments, system 100 can optionally comprise a computer-based Graphical User Interface (GUI) 124 which is configured to enable user-specified inputs related to system 101. For instance, the user can be presented with a visual representation of the specimen (for example, by a display forming part of GUI 124), including the images of the specimen, the defect maps, etc. The user may be provided, through the GUI, with options of defining certain operation parameters. The user may also view the operation results or intermediate processing results, such as, e.g., the verification result, and the verified synthetic images, etc., on the GUI.

In some cases, system 101 can be further configured to send, via I/O interface 126, the operation results to the examination tools 120 and 121 for further processing. In some cases, system 101 can be further configured to send the results to the storage unit 122, and/or external systems (e.g., Yield Management System (YMS) of a fabrication plant (fab)). A yield management system (YMS) in the context of semiconductor manufacturing is a data management, analysis, and tool system that collects data from the fab, especially during manufacturing ramp ups, and helps engineers find ways to improve yield. A YMS helps semiconductor manufacturers and fabs manage high volumes of production analysis with fewer engineers. These systems analyze the yield data and generate reports. A YMS can be used by Integrated Device Manufacturers (IMD), fabs, fabless semiconductor companies, and Outsourced Semiconductor Assembly and Test (OSAT).

Those versed in the art will readily appreciate that the teachings of the presently disclosed subject matter are not bound by the system illustrated in FIG. 1. Each system component and module in FIG. 1 can be made up of any combination of software, hardware, and/or firmware, as relevant, executed on a suitable device or devices, which perform the functions as defined and explained herein. Equivalent and/or modified functionality, as described with respect to each system component and module, can be consolidated or divided in another manner. Thus, in some embodiments of the presently disclosed subject matter, the system may include fewer, more, modified and/or different components, modules, and functions than those shown in FIG. 1.

Each component in FIG. 1 may represent a plurality of the particular components, which are adapted to independently and/or cooperatively operate to process various data and electrical inputs, and for enabling operations related to a computerized examination system. In some cases, multiple instances of a component may be utilized for reasons of performance, redundancy, and/or availability. Similarly, in some cases, multiple instances of a component may be utilized for reasons of functionality or application. For example, different portions of the particular functionality may be placed in different instances of the component.

It should be noted that the examination system illustrated in FIG. 1 can be implemented in a distributed computing environment, in which one or more of the aforementioned components and functional modules shown in FIG. 1 can be distributed over several local and/or remote devices. By way of example, the examination tools 120 and 121, and the system 101, can be located at the same entity (in some cases hosted by the same device) or distributed over different entities. By way of another example, as described above, in some cases, system 101 can be configured as a training system for training the ML models, while in some other cases, system 101 can be configured as a runtime monitoring system using the trained ML models. The training system and the runtime verification system can be located at the same entity (in some cases hosted by the same device), or distributed over different entities, depending on specific system configurations and implementation needs.

In some examples, certain components utilize a cloud implementation, e.g., are implemented in a private or public cloud. Communication between the various components of the examination system, in cases where they are not located entirely in one location or in one physical entity, can be realized by any signaling system or communication components, modules, protocols, software languages, and drive signals, and can be wired and/or wireless, as appropriate.

It should be further noted that in some embodiments at least some of examination tools 120 and 121, storage unit 122 and/or GUI 124 can be external to the examination system 100 and operate in data communication with systems 100 and 101 via I/O interface 126. System 101 can be implemented as stand-alone computer(s) to be used in conjunction with the examination tools, and/or with the additional examination modules as described above. Alternatively, the respective functions of the system 101 can, at least partly, be integrated with one or more examination tools 120 and 121, thereby facilitating and enhancing the functionalities of the examination tools in examination-related processes.

While not necessarily so, the process of operations of systems 101 and 100 can correspond to some or all of the stages of the methods described with respect to FIGS. 2-6. Likewise, the methods described with respect to FIGS. 2-6 and their possible implementations can be implemented by systems 101 and 100. It is therefore noted that embodiments discussed in relation to the methods described with respect to FIGS. 2-6 can also be implemented, mutatis mutandis, as various embodiments of the systems 101 and 100, and vice versa.

Referring to FIG. 2, there is illustrated a generalized flowchart of monitoring/verifying quality of reconstructed images in accordance with certain embodiments of the presently disclosed subject matter.

As described above, a semiconductor specimen is typically made of multiple layers. The examination process of a specimen can be performed a multiplicity of times during the fabrication process of the specimen, for example following the processing steps of specific layers. In some cases, a sampled set of processing steps can be selected for in-line examination, based on their known impacts on device characteristics or yield. Images of the specimen or parts thereof can be acquired at the sampled set of processing steps to be examined.

For the purpose of illustration only, certain embodiments of the following description are described with respect to images of a given processing step/layer of the sampled set of processing steps. Those skilled in the art will readily appreciate that the teachings of the presently disclosed subject matter can be performed following any layer and/or processing steps of the specimen. The present disclosure should not be limited to the number of layers comprised in the specimen and/or the specific layer(s) to be examined.

An input image of a semiconductor specimen can be obtained (202) during runtime examination of the specimen. The input image can be processed (204) using a first ML model (e.g., the first ML model 104), to obtain a synthetic image corresponding to the input image. The first ML model referred to in block 204 is a pre-trained model that has been previously trained in a training phase for image reconstruction for a specific application. The synthetic image is reconstructed to resemble a target image pertaining to the specific application.

As mentioned above, ML-based image reconstruction can be employed for various examination applications of semiconductor specimens, such as, e.g., generating reference images for runtime examination images, generating high-resolution images from low-resolution ones, or creating simulated images (such as SEM images) from design data. For different applications, the input image used in blocks 202 and 204 can refer to different images.

By way of example, in cases where the specific application is reference generation (i.e., generating reference images for examination images acquired in runtime), the input image refers to an original image of the semiconductor specimen that is actually acquired by an examination tool (e.g., by an inspection tool, or a review tool), or any derivatives of the original image (such as resulting from any pre-processing of the original image). In such cases the target image pertaining to the application of reference generation refers to an actual reference image of the original image that is free of defects. The synthetic image in such cases refers to a reconstructed reference image that is expected to be defect-free and usable for comparison with the original image for the purpose of defect detection in the original image.

The original image can be acquired by the inspection tool 120 or the review tool 121 as described above. For instance, the original image can be an optical image acquired by an optical inspection tool, or an electron beam (e-beam) image acquired by an electron beam tool during in-line examination of the specimen, depending on the specific examination modality thereof. A semiconductor specimen here can refer to a semiconductor wafer, a die, or parts thereof, that is fabricated and examined in the fab during a fabrication process thereof. An original image refers to an image capturing at least part of the specimen. By way of example, an image can capture a region or a structure that is of interest to be examined on the specimen.

It should be noted that the terms “actual images” or “images actually acquired” used herein refer to real images that are directly obtained from an examination tool during the inspection or review process. These images are captured by devices such as optical inspection tools, electron beam tools, or other similar examination equipment, and represent the true visual data of the semiconductor specimen at the time of acquisition. On the other hand, the terms “synthetic images,” “reconstructed images,” or “simulated images” used herein refer to images that are artificially generated, typically using machine learning models such as the first ML model mentioned above. These generated images are produced through computational methods and are intended to replicate or enhance the actual images for various purposes, such as defect detection, image enhancement, or simulation.

By way of another example, in cases where the specific application is image enhancement (i.e., generating high-quality images from low-quality images), the input image refers to a low-quality image (in terms of e.g., low-resolution and/or low signal-to-noise ratio (SNR)) of the semiconductor specimen. For instance, the low-quality image can be an original image actually acquired by an examination tool (e.g., a tool with a relatively low resolution, such as an optical tool), or derivatives thereof. The target image in such cases refers to an actual high-quality image of the specimen, such as, e.g., an image acquired by an examination tool with a relatively high resolution, such as by an e-beam tool. The synthetic image in such cases refers to a reconstructed high-quality image (in terms of e.g., high-resolution and/or high SNR) usable for examining the specimen, instead of using the low-quality image.

It should be noted that the terms “high” and “low” as used herein with respect to image quality, resolution, and signal-to-noise ratio (SNR), are intended to be understood as relative terms rather than absolute terms. Specifically, for instance, a “high-quality image” is one that has relatively higher quality (e.g., higher resolution and/or higher SNR) compared to a “low-quality image.” The determination of “high” or “low” can be sometimes based on comparison to a predefined threshold or a specified range. For instance, a high-resolution image may be defined as having a resolution above a certain threshold, while a low-resolution image may be one that falls below this threshold. Similarly, a high SNR image may be defined as having an SNR above a certain value, whereas a low SNR image has an SNR below this value. These thresholds or ranges can be predetermined based on the specific requirements of the application or the standards set by the industry. Therefore, the terms “high” and “low” are to be interpreted contextually, and are relative to each other or to predefined criteria.

By way of further example, in cases where the specific application is image simulation (i.e., generating simulated images from design data), the input image refers to a design image of the semiconductor specimen which can be derived based on design data (e.g., CAD) of the specimen. The synthetic image in such cases refers to a simulated image resembling a target image pertaining to this specific application, i.e., an actual image of the specimen acquired by an examination tool. For instance, the synthetic image can be a simulated SEM image that is generated to simulate the physical effects of the SEM tool during image acquisition.

Taking the specific application of reference generation for example, as described above, for the purpose of avoiding any disadvantages associated with acquiring an actual reference image, such as doubled tool time for image acquisition and additional image processing for noise/variation compensation, etc., the first ML model is used to generate a synthetic reference image. The first ML model is thus also referred to as a generative model or a reconstruction model. A generative model used herein refers to a ML model that is trained to learn to generate new data instances. A generative model as used herein can be trained in different manners using supervised learning or unsupervised learning.

By way of example, in some cases, the first ML model can be trained using supervised learning. For instance, a training set comprising one or more pairs of training images of a training specimen can be obtained, each pair including a defective image and a corresponding reference image. The first ML model can be trained using supervised learning based on the training set.

A defective image used herein refers to an image that comprises, or has a high probability of comprising, defective features representative of actual defects on a specimen. The reference image corresponds to the defective image in a sense that it captures a similar region containing similar patterns as of the defective image. The reference image serves as the ground truth data associated with the defective image in the same pair. The ML model is trained to learn the non-linear mapping relationship between the two populations of defective images and reference images.

In some cases, the training images, such as the defective image and the reference image in each pair, can be “real world” images (i.e., actual images) of a semiconductor specimen acquired by an examination tool during a fabrication process of the specimen. In some cases, at least one of the defective images, and/or the reference image in a pair, can be a simulated image. By way of example, the reference image can be simulated based on the design data of the semiconductor specimen.

The training of the first ML model can comprise, for each pair of the one or more pairs of training images, processing the defective image by the first ML model to obtain a predicted image, and optimizing the first ML model to minimize a difference between the predicted image and the reference image. In some cases, the defective image and the reference image in each pair can be pre-processed before being fed to the ML model for training the model for the purpose of reducing the impacts of variations, such as process variations, gray level variations, etc., which are caused by certain physical processes of the specimens. The pre-processing can comprise one or more of the following operations: image registration, noise filtration, and image augmentation.

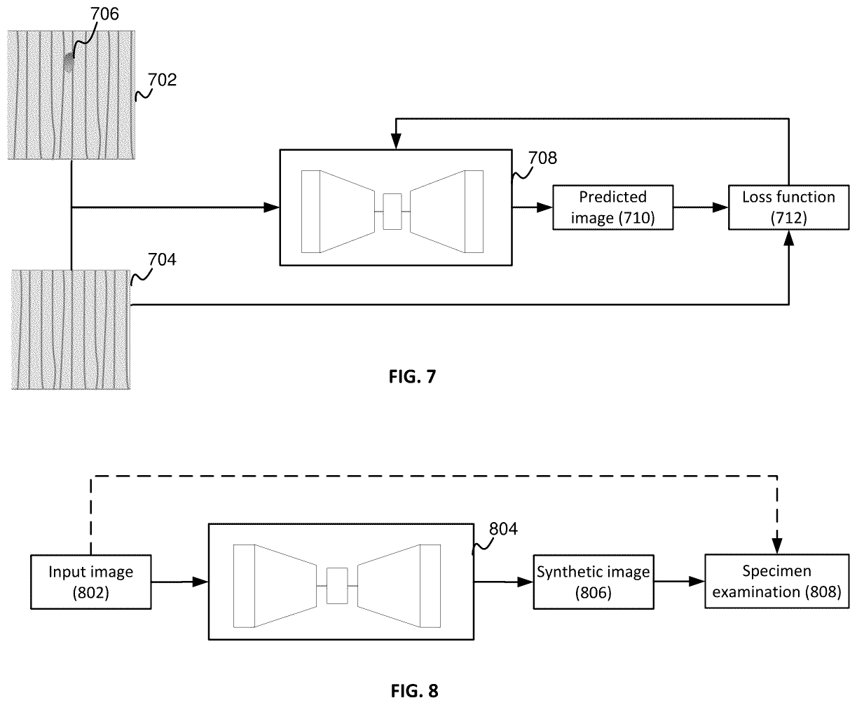

FIG. 7 shows a schematic illustration of an exemplary training process of the first ML model in accordance with certain embodiments of the presently disclosed subject matter.

A pair of training images including a defective image 702 and a defect-free image 704 are exemplified. As shown, the defective image 702 comprises a defective feature 706 (such as, e.g., a bridge formed between two line structures). The defect-free image 704 corresponds to the defective image 702 (e.g., it captures an area having similar patterns as of the defective image), and does not comprise any defective feature. In some cases, optionally, the defective image and the defect-free image in each pair can be pre-processed (e.g., including image registration, noise filtration, and image augmentation) before being fed to the ML model for training the model.

The defective image (or pre-processed defective image) is fed into the ML model 708 to be processed. The output of the ML model 708 is a predicted image 710. The predicted image 710 is evaluated with respect to the defect-free image 704 (which serves as ground truth data for the predicted image) using a loss function 712 (also referred to as cost function). The loss function 712 can be a difference metric configured to represent a difference between the predicted image and the defect-free image. The ML model 708 can be optimized by minimizing the value of the loss function 712. By way of example, the ML model 708 can be optimized using a loss function such as, e.g., Mean squared error (MSE), Sum of absolute difference (SAD), structural similarity index measure (SSIM), or an edge-preserving loss function. It is to be noted that the term “minimize” or “minimizing” used herein refers to an attempt to reduce a difference value represented by the loss function to a certain level/extent (which can be predefined), but does not necessarily have to reach the actual minimum.

Similarly, in cases of the specific application of image enhancement, the training set can comprise one or more pairs of training images, where each pair includes a low-quality training image and a corresponding high-quality image as the ground truth image of the low-quality training image. In cases of the specific application of image simulation, the training set can comprise one or more pairs of training images, where each pair includes a design training image and a corresponding simulated image as the ground truth image of the design training image.

Therefore, it can be derived that in supervised learning, the first ML model can be previously trained using a training set comprising one or more pairs of training images, each pair including a training image and a corresponding ground truth image with respect to the specific application.

In some other cases, alternatively, the first ML model can be trained using unsupervised learning based on a training set of nominal images of one or more training specimens. A nominal image is also referred to as a defect-free image. It is a clean image, free of defective features, or has a high probability of not comprising any defective features. The training set of nominal images can be collected from “real-world”/actual images of the training specimens, or, alternatively, at least part of the images can be simulated, based on design data of the specimens.

By way of example, the first ML model can be implemented as an autoencoder (AE) or variations thereof (e.g., VAE). Autoencoder is a type of neural network commonly used for the purpose of data reproduction by learning efficient data coding and reconstructing its inputs (e.g., minimizing the difference between the input and the output). The autoencoder has an input layer, an output layer, and one or more hidden layers connecting them. Generally, an autoencoder can be regarded as including two parts, the encoder network and the decoder network. The autoencoder learns to compress data from an input layer into a short code (i.e., the encoder network), and then decompress that code into an output that closely matches the original data (i.e., the decoder network). The output of the encoder is referred to as code, latent variables, or latent representation representative of the input image. The code can pass the hidden layers in the decoder, and can be reconstructed to an output image corresponding to the input image in the output layer.

For each input nominal image in the training set, the autoencoder can extract features representative of the input image, and use the representative features to reconstruct a corresponding output image which can be evaluated by comparing with the input image. The autoencoder is trained and optimized so as to learn the representative features in the input training images (e.g., the features can be representative of, e.g., structural elements, patterns, pixel distribution, etc., in the training images). As the training images are nominal images, the autoencoder is trained to learn the distribution of normal patterns and characteristics of defect-free images.

Once the autoencoder is trained based on the training set, the trained autoencoder is capable of generating, for each input image, a reconstructed output image that closely matches the input, based on the latent representation thereof. As the autoencoder is trained with only nominal images, it will not be able to reconstruct anomaly patterns (defective patterns) that were not observed during training. In cases where the input image is a defective image, the autoencoder will reconstruct a corresponding defect-free image of the defective image. Therefore, the trained autoencoder can be used for generating a synthetic reference image for a given real/actual image of a specimen which is actually acquired by an examination tool.

Except for the autoencoder, the first ML model can be implemented as various models, such as, e.g., a generative adversarial network (GAN), Vision Transformer (ViT), etc., with unsupervised learning mode.

Upon being trained, the first ML model can be used in runtime examination. FIG. 8 shows a schematic illustration of an exemplary runtime examination process using a trained first ML model in accordance with certain embodiments of the presently disclosed subject matter. An input image 802 is fed into a trained first ML model 804 to be processed. The first ML model 804 has been previously trained as described above. Upon processing the image 802, the first ML model 804 provides a synthetic image 806 as an output.

In cases of a specific application of reference generation, the input image 802 is an original image of a specimen acquired by an inspection tool, and the synthetic image 806 is a reconstructed reference image of the original image. The input image 802, together with the synthetic image 806, are provided to a specimen examination module 808, such as an ADR/ADC module, or a metrology module, for the purpose of further examination on the specimen. In cases of a specific application of image enhancement, the input image 802 is a low-quality image, and the synthetic image 806 is a reconstructed high-quality image. The synthetic image 806 is provided to the specimen examination module 808 to be processed, instead of the input image 802 for further examination. In cases of a specific application of image simulation, the input image 802 is a design image, and the synthetic image 806 is, e.g., a simulated SEM image which is then provided to the specimen examination module 808 to be processed.

Continuing with the description of FIG. 2, upon the synthetic image being generated, the synthetic image, together with one of the input image or the target image of the synthetic image, can be processed (206) by a second ML model (e.g., the second ML model 106), to obtain a defect map indicative of defect distribution in the input image or the target image with respect to the synthetic image. It is to be noted that the term “defect map” used herein can refer to a probability score map, which comprises pixelwise scores representing the probabilities of a defect being present in respective pixels of the corresponding input image, or refer to a binary map where a value of 1 indicates presence of a defect at a corresponding pixel, while a value of 0 indicates no defect presence.

The second ML model has been previously trained during a training phase for defect detection, thus can be also referred to as a detection model. The second ML model can be generally employed in a defect detection system or an ADR system, where an input image and a reference image thereof are provided as input to the second model. For instance, in cases where a target die is to be inspected with respect to its neighboring die, the second ML model can be used to process an input image of the target die and a reference image of the reference die together, and provide a defect map for the input image of the target die.

According to certain embodiments of the present disclosure, in cases where the specific application is reference generation, the input image is an original image acquired by an examination tool, and the synthetic image is a reconstructed reference image, the second ML model is used to process the synthetic image (i.e., the reconstructed reference image) and the input image (i.e., the original image) to obtain a defect map indicative of defect distribution in the input image with respect to the synthetic image.

In cases where the specific application is image enhancing, the input image is a low-quality image of the specimen, the synthetic image is a reconstructed high-quality image, and the target image is an actual high-quality image acquired by an examination tool. The second ML model is used to process the synthetic image and the target image (i.e., the actual high-quality image) to obtain a defect map indicative of defect distribution in the target image with respect to the synthetic image.

In cases where the specific application is image simulation, the input image is a design image of the specimen, the target image is an actual image (e.g., an actual SEM image) of the specimen acquired by an examination tool, and the synthetic image is a simulated image (e.g., a simulated SEM image) resembling the target image. The second ML model is used to process the synthetic image and the target image (i.e., the actual image of the specimen) to obtain a defect map indicative of defect distribution in the target image with respect to the synthetic image.

In some embodiments, the second ML model can be previously trained in a training phase using supervised learning. By way of example, the second ML model can be trained using a training set comprising one or more pairs of training images, each pair including an input training image (which is either defective or defect-free) and a corresponding reference image. The input training image is associated with ground truth defect information thereof.

The training of the second ML model can comprise, for each pair of the one or more pairs of training images, processing the input training image and the corresponding reference image by the second ML model to obtain a predicted defect map, and optimizing the second ML model using a loss function to minimize a difference between the predicted defect map and the ground truth defect information of the input training image.

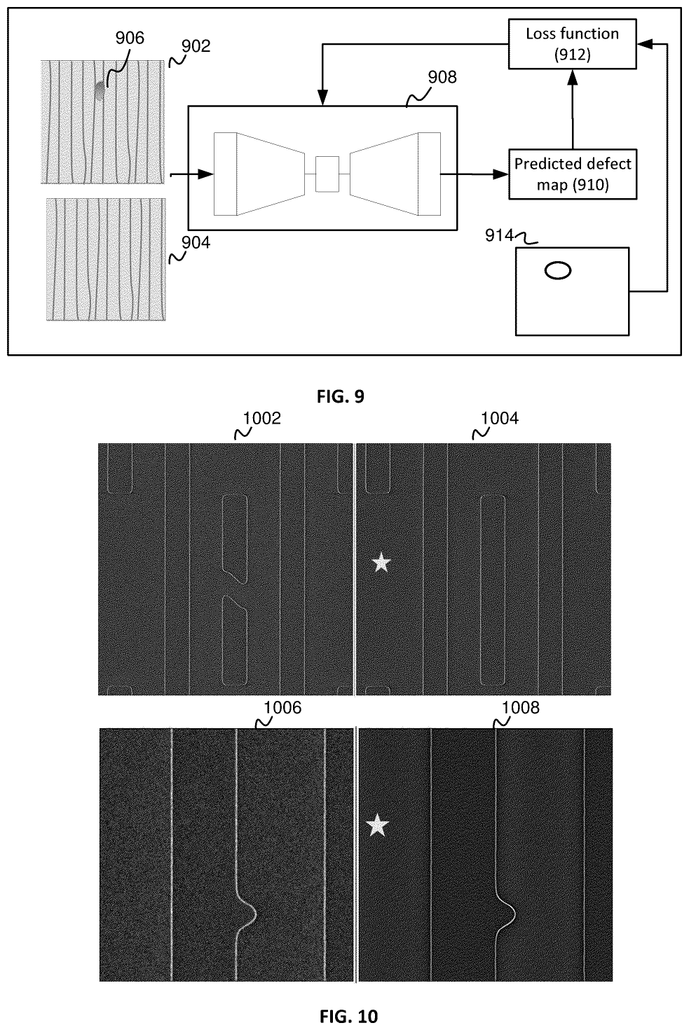

FIG. 9 shows a schematic illustration of an exemplary training process of the second ML model in accordance with certain embodiments of the presently disclosed subject matter.

A pair of training images including an input training image 902 (a defective image in the present example) and a corresponding reference image 904 (a defect-free image) are exemplified. As shown, the input training image 902 comprises a defective feature 906 (such as, e.g., a bridge formed between two line structures). The reference image 904 corresponds to the input training image 902 (e.g., it captures an area having similar patterns as of the defective image), and does not comprise any defective feature.

The input training image 902 and the reference image 904 are fed into the second ML model 908 to be processed. The output of the ML model 908 is a predicted defect map 910 of the input training image 902. The predicted defect map 910 is evaluated using a loss function 912, with respect to the ground truth defect information 914 indicative of the presence of the defective feature 906 of the input training image 902. The loss function 912 can be a difference metric configured to represent a difference between the predicted defect map 910 and the ground truth defect information 914. The second ML model 908 can be optimized by minimizing the value of the loss function 912. By way of example, the ML model 908 can be optimized using a loss function such as, e.g., Mean squared error (MSE), Sum of absolute difference (SAD), structural similarity index measure (SSIM), or an edge-preserving loss function.

In some cases, the second ML model can be trained using a training set comprising one or more training images each associated with ground truth defect information thereof (without reference images). By way of example, the training of the second ML model can comprise, for each training image in the training set, processing the training image by the second ML model to obtain a predicted defect map, and optimizing the second ML model using a loss function to minimize a difference between the predicted defect map and the ground truth defect information of the training image.

In some cases, the second ML model can be trained in both modes, one mode with training image pairs including input and reference images (as exemplified in FIG. 9), and one mode without reference images. In such cases, the second ML model, when employed in runtime, can operate in two modes: processing a single runtime image as input to provide a defect map thereof (also referred to as single image detection), and/or processing an input of two images including a runtime image and a reference image to provide a defect map of the runtime image.

Continuing with the description of FIG. 2, quality of the synthetic image generated by the first ML model can be verified (208) (e.g., by the monitoring module 108) based on the defect map generated by the second ML model. Specifically, as illustrated in FIG. 3, the quality of the synthetic image can be verified by comparing (302) the defect map with ground truth defect information of the input image or the target image, and verifying (304), based on the comparison, whether an unexpected defect is present in the synthetic image during the image reconstruction.

The unexpected defect may be caused due to the unpredictable behavior of the ML model, which leads to the introduction of artificial defects and variations. By way of example, the unexpected defect can represent one of: an original defect that was supposed to be removed during image reconstruction, or an artificial defect that was introduced during image reconstruction. For instance, in the application of reference generation, assume the input image to the first ML model contains an original defect. The synthetic image outputted by the first ML model is a reconstructed reference image that is supposed to be defect-free. However, in some cases, the defect that should be removed may not be completely eliminated, thus is still partially present/visible in the reconstructed reference image. In some other cases, irrespective of whether the input image to the first ML model contains an original defect or not, an artificial defect that was originally non-existent in the input image may be introduced during the image reconstruction, thus being present in the reconstructed reference image. This may cause false alarms in the detection result, thus compromising the detection performance.

FIG. 10 illustrates examples of unexpected defects in accordance with certain embodiments of the presently disclosed subject matter.

An input image 1002 illustrates an original image capturing line structures where a defect (e.g., a cut) is present in one of the lines. Upon the input image 1002 being processed by the first ML model, a synthetic image 1004 is generated as a reconstructed reference image of the input image 1002. As shown, the original defect is successfully removed in the synthetic image 1004. However, an unexpected artificial defect (denoted by a star) was introduced during the reconstruction process.

Another example of an input image 1006 illustrates a low-quality (e.g., low SNR) image which may be acquired by an optical tool. Upon the input image 1006 being processed by the first ML model, a synthetic image 1008 is generated as a reconstructed high-quality image of the input image 1006. As shown, an unexpected artificial defect (denoted by a star) was introduced in the synthetic image 1008 during the reconstruction process. In the presence of these artificial defects, it indicates that the first ML model does not function as expected, which should be monitored and reported.

As mentioned above, the verification of presence of unexpected defects is based on a comparison between the defect map with ground truth defect information of the input image or the target image. The ground truth defect information can be obtained in various manners. By way of example, in some cases, the ground truth defect information can be provided by manual annotation. In some other cases, the ground truth defect information can be provided by a defect detection algorithm, such as, e.g., a legacy D2R detection algorithm, or detection provided by the second ML model.

By way of example, in cases of the specific application being reference generation, the second ML model processes the input image and the synthetic image to provide a defect map of the input image. The quality of the synthetic image (i.e., the reconstructed reference image) can be verified/evaluated by comparing the defect map of the input image with ground truth defect information of the input image. The ground truth defect information in such cases can be provided in various ways. For instance, a real/actual reference image of the input image can be acquired by the examination tool during inspection, which is provided, together with the input image, to the second ML model to be processed. The output defect map can be used as the ground truth defect information of the input image. Alternatively, the second ML model can operate in the single image detection mode, as described above. The second ML model can process the input image by itself and provide an output defect map, which can be used as the ground truth defect information of the input image.

In such cases (reference generation), when the input image is a defective image, such as the exemplary image 1002, the first ML model is supposed to output a synthetic image as a reconstructed reference image that is defect-free. The second ML model, upon processing the input image and the synthetic image, will output a defect map indicative of defect distribution in the input image. The defect map, when being compared with the ground truth of the input image, is supposed to match the ground truth defect information. In cases of a mismatch, this indicates that the first ML model does not reconstruct images as expected, and that artifacts have been introduced.

For instance, in the example of FIG. 10 where the reconstructed reference image 1004 has introduced an unexpected artificial defect, the defect map outputted by the second ML model would indicate two defects, including the original defect (e.g., the cut) that was already present in image 1002, as well as the added artificial defect, while the ground truth defect information of image 1002 would only indicate the original defect. Such a mismatch should be reported and investigated.

When the input image is a non-defective original image, e.g., a nominal image without any defect, the ground truth defect information associated with the input image should indicate absence of defects. The first ML model is still supposed to output a synthetic image as a defect-free reference image of the input image. The second ML model, upon processing the input image and the synthetic image, will output a defect map indicative of no defect presence in the input image. The defect map is supposed to match the ground truth defect information. In cases of a mismatch, such as the presence of an added artificial defect, it is verified that an unexpected defect is present and that a malfunction of the first ML model exists.

In cases of the specific application being image enhancement, where the input image is a low-quality image, such as the exemplary image 1006, the ground truth defect information associated with the input image should indicate absence of defects. The first ML model is supposed to output a synthetic image that is a reconstructed high-quality image. The second ML model, upon processing the synthetic image and a target image thereof (e.g., an actual high-quality image), will output a defect map indicative of no defect presence in the input image. The defect map is supposed to match the ground truth defect information. In cases of a mismatch, such as the presence of an added artificial defect, as exemplified in image 1008, it is identified that an unexpected defect is present, and that a malfunction of the first ML model exists.

Similarly, in cases of the specific application being image simulation, where the input image is a design image derived based on design data, the ground truth defect information associated with the input image should also indicate absence of defects. The first ML model is supposed to output a synthetic image that is a simulated image (e.g., simulated SEM image). The second ML model, upon processing the synthetic image and a target image thereof (e.g., an actual SEM image), will output a defect map indicative of no defect presence in the input image. The defect map is supposed to match the ground truth defect information. In cases of a mismatch, such as the presence of an added artificial defect, it is identified that a malfunction of the first ML model exists.

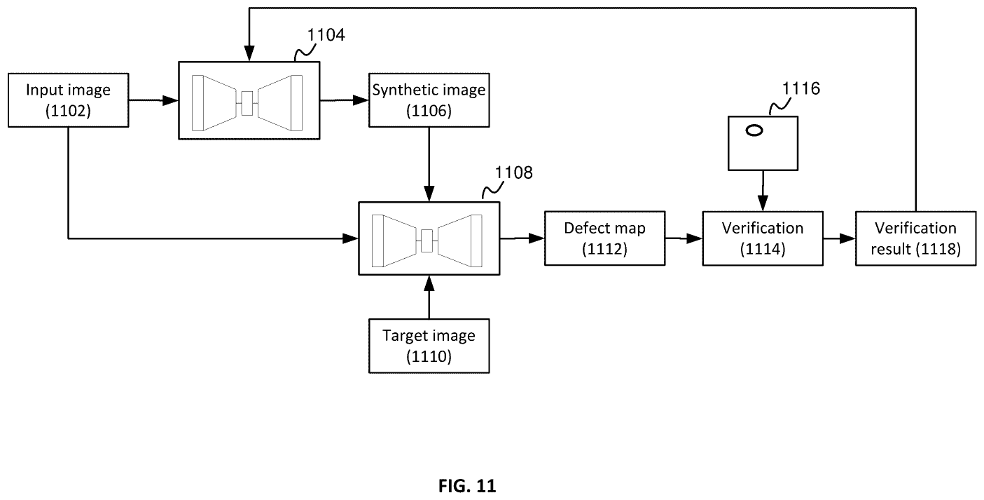

FIG. 11 shows a schematic illustration of a runtime verification process as described above with reference to FIG. 2 in accordance with certain embodiments of the presently disclosed subject matter.

An input image 1102 is acquired and provided as input to the first ML model 1104. Upon processing the input image, the first ML model 1104 outputs a synthetic image 1106. Depending on the specific application, the second ML model 1108 will process the synthetic image 1106 and either the input image 1102 or the target image 1110 of the synthetic image 1106, to obtain a defect map 1112 indicative of defect distribution (e.g., spatial distribution) in the input image 1102 or the target image 1110 with respect to the synthetic image 1106. For instance, when the specific application is reference generation, the second ML model 1108 will process the synthetic image 1106 and the input image 1102 to provide the defect map of the input image. When the specific application is image enhancing or image simulation, the second ML model 1108 will process the synthetic image 1106 and the target image 1110 of the synthetic image to provide the defect map of the target image 1110.

Upon the defect map 1112 being generated, it can be used to verify (by the verification module 1114) the quality of the synthetic image 1106. Specifically, the defect map 1112 is compared with the ground truth defect information 1116 of the input image or the target image (depending on the application). It can be verified, based on the comparison, whether an unexpected defect is present in the synthetic image 1106 during reconstruction by the first ML model 1104. The verification result 1118, indicative of the presence of an unexpected defect, can be used to tune the first ML model 1104 and adjust the model parameters thereof.

By way of example, the verification result, indicative of the presence of the unexpected defect in the synthetic image, can be used to prepare a refined training set, and the first ML model can be retrained using the refined training set. For instance, the unexpected defect, as detected in the verification result, can be included in the refined training set and used to train the first ML model.

It is to be noted that the first and second ML models 1104 and 1108 have both been trained in a training/setup phase prior to the runtime employment. According to certain embodiments, in some cases, the first and second ML models can be trained separately. In some cases, the second ML model is trained prior to the training of the first ML model. Alternatively, the second ML model can be trained together with the training of the first ML model.

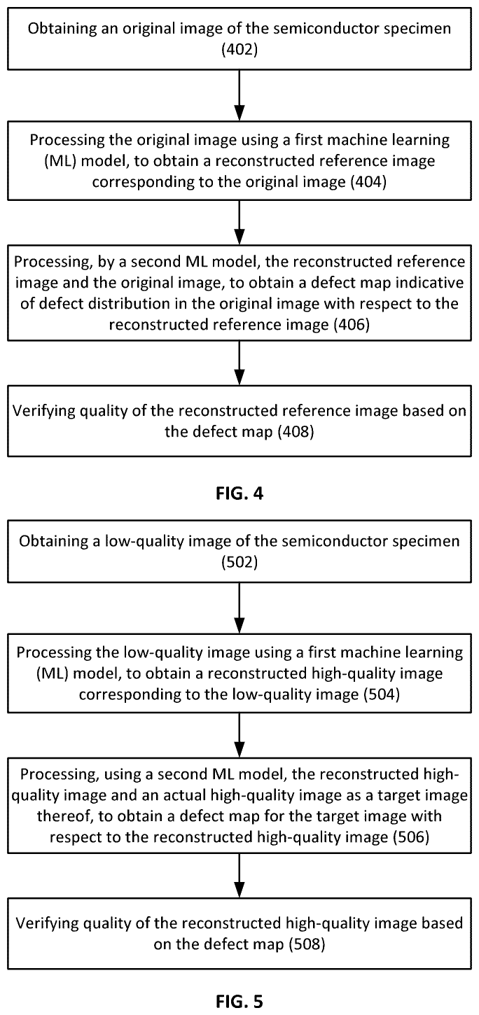

As specified above, the verification process can be applied to various applications. FIGS. 4-6 illustrate generalized flowcharts of applying the verification process in different applications in accordance with certain embodiments of the presently disclosed subject matter.

Specifically, FIG. 4 illustrates a flowchart of applying the verification process in a reference generation application.

An input image of the semiconductor specimen can be obtained (402). As described above, the input image in such cases can refer to an original image of the specimen that is actually acquired by an examination tool (e.g., by an inspection tool, or a review tool), or any derivatives of the original image (such as resulting from any pre-processing of the original image).

The input image (i.e., the original image) can be processed (404) using a first machine learning (ML) model, to obtain a synthetic image, which, in such cases, refers to a reconstructed reference image corresponding to the input image, and is expected to be defect-free.

A second ML model can be used to process (406) the synthetic image (i.e., the reconstructed reference image) and the input image (i.e., the original image), to obtain a defect map indicative of defect distribution in the original image with respect to the reconstructed reference image. Quality of the reconstructed reference image can be verified (408) based on the defect map, such as, e.g., verifying whether there is any presence of an unexpected defect occurring in the synthetic image during the image reconstruction.

FIG. 5 illustrates a flowchart of applying the verification process in an image enhancement application.

An input image of the semiconductor specimen can be obtained (502). The input image in such cases can refer to a low-quality image of the specimen (in terms of e.g., low-resolution and/or low signal-to-noise ratio (SNR)) actually acquired by an examination tool.

The input image (i.e., the low-quality image) can be processed (504) using a first ML model, to obtain a synthetic image, which, in such cases, refers to a reconstructed high-quality image corresponding to the low-quality image.

A second ML model can be used to process (506) the synthetic image (i.e., the reconstructed high-quality image) and a target image thereof (i.e., an actual high-quality image), to obtain a defect map indicative of defect distribution in the actual high-quality image with respect to the reconstructed high-quality image. Quality of the reconstructed high-quality image is verified (508) based on the defect map, such as, e.g., verifying whether there is any presence of an unexpected defect during the reconstruction.

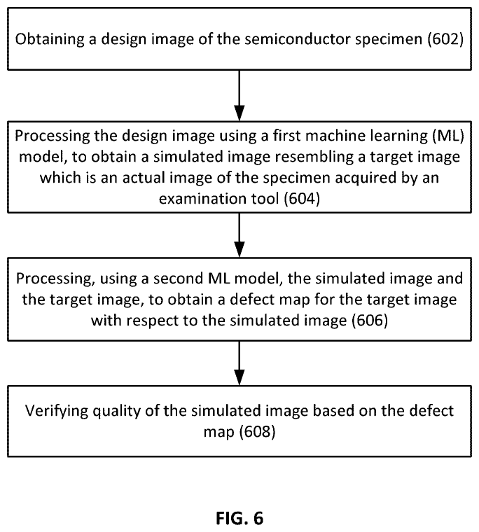

FIG. 6 illustrates a flowchart of applying the verification process in an image simulation application.

An input image of the semiconductor specimen can be obtained (602). The input image in such cases can refer to a design image of the specimen derived based on design data of the specimen.

The input image (i.e., the design image) can be processed (604) using a first ML model, to obtain a synthetic image, which, in such cases, refers to a simulated image resembling the target image which is an actual image of the specimen acquired by an examination tool.

A second ML model can be used to process (606) the synthetic image (i.e., the simulated image) and the target image thereof (i.e., an actual SEM image), to obtain a defect map indicative of defect distribution in the actual image with respect to the reconstructed simulated image. Quality of the simulated image is verified (608) based on the defect map, such as, e.g., verifying whether there is any presence of unexpected defects during the reconstruction.

The runtime verification process, as shown in FIGS. 2-6, can be performed in an ongoing manner, to continuously monitor the image reconstruction functionality of the first ML model. This process can be configured to operate periodically, such as hourly, daily, or weekly, according to the specific needs of the user. The user has the flexibility to set a fixed frequency for the verification process, enabling the system to operate as per a predetermined schedule. For instance, the verification system can be programmed to activate at a fixed time each day, during which the verification process is executed for a certain time period. During this time, the first ML model remains operational in the runtime environment for image reconstructions.

The periodic verification ensures that the quality of the synthetic images generated by the first ML model is consistently monitored. The verification result is subsequently reviewed and analyzed to assess the presence of any unexpected defects. In cases where unexpected defects are detected, an alarm can be triggered to notify the user promptly. This immediate notification allows the user to take corrective actions, ensuring that any issues with the image reconstruction process are addressed in a timely manner.

The verification results can serve a dual purpose. First, they provide an immediate indication of any anomalies in the synthetic images, ensuring the reliability of the image reconstruction process. Second, they offer valuable feedback for the continuous improvement of the first ML model. By analyzing the verification results, the user can identify specific areas where the first ML model may require tuning. Adjustments can be made to the model parameters based on the verification feedback, enhancing the accuracy and reliability of future image reconstructions.

For example, if the verification process identifies recurring unexpected defects at certain intervals, the user can use this information to refine the training dataset or adjust the learning parameters of the first ML model. This iterative tuning process helps in progressively improving the model's performance, reducing the likelihood of future defects, and ensuring that the synthetic images meet the desired quality standards.

Moreover, the system's ability to operate the verification process automatically according to a fixed schedule ensures that the monitoring is consistent and does not rely on manual intervention. This automated approach enhances the efficiency of the verification process, allowing for continuous quality control without disrupting the ongoing image reconstruction operations of the first ML model. The results of the verification can be stored and tracked over time, providing a comprehensive log of the model's performance and facilitating long-term analysis and improvements.

By implementing such a periodic and automated verification process, the present disclosure ensures that the image reconstruction functionality of the first ML model remains robust and reliable. It offers a proactive approach to maintaining high-quality image reconstruction capabilities in semiconductor examination, ultimately leading to more accurate defect detection and improved overall performance in other related applications of the examination systems.

It is to be noted that examples illustrated in the present disclosure, such as, e.g., the exemplified ML models and structures, the exemplary images and defects, the loss functions, the training datasets, etc., are illustrated for exemplary purposes, and should not be regarded as limiting the present disclosure in any way. Other appropriate examples/implementations can be used in addition to, or in lieu of the above.

Among advantages of certain embodiments of the presently disclosed subject matter as described herein, is the capability of artificial defect detection in reconstructed images of semiconductor specimens. This is enabled at least by the use of a second ML model that processes synthetic images reconstructed by a first ML model and corresponding input or target images to generate a defect map. By comparing this defect map with ground truth defect information, the quality of the synthetic images can be verified, ensuring that the first ML model does not introduce artificial defects, nor fails to remove existing defects during image reconstruction.

Among advantages of certain embodiments of the presently disclosed subject matter as described herein, is the ability to perform continuous and automated quality monitoring of synthetic images reconstructed by a first ML model. This can be enabled by the runtime verification process as described above with references to FIGS. 2-6, which can be scheduled to operate in a periodic manner during runtime examination. The verification system can automatically activate at predetermined times to execute the verification process, analyze the results, and notify the user in case of unexpected defects. This automated approach ensures consistent quality control without manual intervention, maintaining the reliability of the first ML model's image reconstruction functionality.

Among advantages of certain embodiments of the presently disclosed subject matter as described herein, is the capability to apply the verification process across various applications, including reference generation, image enhancement, and image simulation. This can be enabled by the adaptability of the first and second ML models to process different types of input images and/or target images, depending on the specific application, whether it is an original inspection image, a low-quality image, or a design image. This versatility ensures that the quality verification can be effectively applied, regardless of the specific use case, making the proposed solution broadly applicable across different examination applications.

Among advantages of certain embodiments of the presently disclosed subject matter as described herein, is the iterative improvement of the first ML model based on verification feedback. The verification results provide detailed information on the nature and location of detected defects or artifacts. This feedback can be used to retrain the first ML model with refined datasets, allowing for adjustments in the model parameters. This iterative tuning process ensures continuous enhancement of the model's performance, reducing the likelihood of future defects and improving the overall quality of the synthetic images.

It is to be understood that the present disclosure is not limited in its application to the details set forth in the description contained herein or illustrated in the drawings.

In the present detailed description, numerous specific details are set forth in order to provide a thorough understanding of the disclosure. However, it will be understood by those skilled in the art that the presently disclosed subject matter may be practiced without these specific details. In other instances, well-known methods, procedures, components, and circuits have not been described in detail so as not to obscure the presently disclosed subject matter.

Unless specifically stated otherwise, as apparent from the present discussions, it is appreciated that throughout the specification discussions utilizing terms such as “obtaining”, “examining”, “reconstructing”, “processing”, “using”, “providing”, “verifying”, “comparing”, “acquiring”, “retraining”, “simulating”, “training”, “optimizing”, “repeating”, or the like, refer to the action(s) and/or process(es) of a computer that manipulate and/or transform data into other data, said data represented as physical, such as electronic, quantities and/or said data representing the physical objects.

The terms “computer”, “computer-based system” or “computerized system” should be expansively construed to cover any kind of hardware-based electronic device with a data processing circuitry (e.g., digital signal processor (DSP), a graphics processing unit (GPU), a field programmable gate array (FPGA), including, by way of non-limiting example, the examination system, the image reconstruction monitoring/verification system, and respective parts thereof disclosed in the present application. The data processing circuitry (designated also as processing circuitry) can comprise, for example, one or more processors operatively connected to computer memory, loaded with executable instructions for executing operations, as further described below. The data processing circuitry encompasses a single processor or multiple processors, which may be located in the same geographical zone, or may, at least partially, be located in different zones, and may be able to communicate together.

The one or more processors referred to herein can represent one or more general-purpose processing devices such as a microprocessor, a central processing unit, or the like. More particularly, a given processor may be one of a complex instruction set computing (CISC) microprocessor, a reduced instruction set computing (RISC) microprocessor, a very long instruction word (VLIW) microprocessor, a processor implementing other instruction sets, or a processor implementing a combination of instruction sets. The one or more processors may also be one or more special-purpose processing devices such as an application specific integrated circuit (ASIC), a field programmable gate array (FPGA), a digital signal processor (DSP), a network processor, or the like. The one or more processors are configured to execute instructions for performing the operations and steps discussed herein.

The memories referred to herein can comprise one or more of the following: internal memory, such as, e.g., processor registers and cache, etc., main memory such as, e.g., read-only memory (ROM), flash memory, dynamic random access memory (DRAM) such as synchronous DRAM (SDRAM) or Rambus DRAM (RDRAM), etc.

The terms “non-transitory memory” and “non-transitory storage medium” used herein should be expansively construed to cover any volatile or non-volatile computer memory suitable to the presently disclosed subject matter. The terms should be taken to include a single medium or multiple media (e.g., a centralized or distributed database, and/or associated caches and servers) that store the one or more sets of data and/or instructions. The terms shall also be taken to include any medium that is capable of storing or encoding a set of instructions for execution by the computer and that cause the computer to perform any one or more of the methodologies of the present disclosure. The terms shall accordingly be taken to include, but not be limited to, a read only memory (“ROM”), random access memory (“RAM”), magnetic disk storage media, optical storage media, flash memory devices, etc.

The term “specimen” used in this specification should be expansively construed to cover any kind of physical objects or substrates including wafers, masks, reticles, and other structures, combinations and/or parts thereof used for manufacturing semiconductor integrated circuits, magnetic heads, flat panel displays, and other semiconductor-fabricated articles. A specimen is also referred to herein as a semiconductor specimen, and can be produced by manufacturing equipment executing corresponding manufacturing processes.

The term “examination” used in this specification should be expansively construed to cover any kind of operations related to defect detection, defect review, and/or defect classification of various types, segmentation, and/or metrology operations during and/or after the specimen fabrication process. Examination is provided by using non-destructive examination tools during or after manufacture of the specimen to be examined. By way of non-limiting example, the examination process can include runtime scanning (in a single or in multiple scans), imaging, sampling, detecting, reviewing, measuring, classifying, and/or other operations provided with regard to the specimen or parts thereof, using the same or different inspection tools. Likewise, examination can be provided prior to manufacture of the specimen to be examined, and can include, for example, generating an examination recipe(s) and/or other setup operations. It is noted that, unless specifically stated otherwise, the term “examination”, or its derivatives used in this specification, is not limited with respect to resolution or size of an inspection area. A variety of non-destructive examination tools includes, by way of non-limiting example, scanning electron microscopes (SEM), atomic force microscopes (AFM), optical inspection tools, etc.

The term “metrology operation” used in this specification should be expansively construed to cover any metrology operation procedure used to extract metrology information relating to one or more structural elements on a semiconductor specimen. In some embodiments, the metrology operations can include measurement operations, such as, e.g., critical dimension (CD) measurements performed with respect to certain structural elements on the specimen, including but not limiting to the following: dimensions (e.g., line widths, line spacing, contact diameters, size of the element, edge roughness, gray level statistics, etc.), shapes of elements, distances within or between elements, related angles, overlay information associated with elements corresponding to different design levels, etc. Measurement results such as measured images are analyzed, for example, by employing image-processing techniques. Note that, unless specifically stated otherwise, the term “metrology”, or derivatives thereof used in this specification, is not limited with respect to measurement technology, measurement resolution, or size of inspection area.

The term “defect” used in this specification should be expansively construed to cover any kind of abnormality or undesirable feature/functionality formed on a specimen. In some cases, a defect may be a defect of interest (DOI) which is a real defect that has certain effects on the functionality of the fabricated device, thus is in the customer's interest to be detected. For instance, any “killer” defects that may cause yield loss can be indicated as a DOI. In some other cases, a defect may be a nuisance (also referred to as “false alarm” defect) which can be disregarded because it has no effect on the functionality of the completed device and does not impact yield.

The term “defect candidate” used in this specification should be expansively construed to cover a suspected defect location on the specimen which is detected to have relatively high probability of being a defect of interest (DOI). Therefore, a DOI candidate, upon being reviewed/tested, may actually be a DOI, or, in some other cases, it may be nuisances, or random noise that can be caused by different variations (e.g., process variation, color variation, mechanical and electrical variations, etc.) during inspection.

The term “design data” used in the specification should be expansively construed to cover any data indicative of hierarchical physical design (layout) of a specimen. Design data can be provided by a respective designer and/or can be derived from the physical design (e.g., through complex simulation, simple geometric and Boolean operations, etc.). Design data can be provided in different formats as, by way of non-limiting examples, GDSII format, OASIS format, etc. Design data can be presented in vector format, grayscale intensity image format, or otherwise.

The term “image(s)” or “image data” used in the specification should be expansively construed to cover any original images/frames of the specimen captured by an examination tool during the fabrication process, derivatives of the captured images/frames obtained by various pre-processing stages, and/or computer-generated synthetic images (in some cases based on design data). Depending on the specific way of scanning (e.g., one-dimensional scan such as line scanning, two-dimensional scan in both x and y directions, or dot scanning at specific spots, etc.), image data can be represented in different formats, such as, e.g., as a gray level profile, a two-dimensional image, or discrete pixels, etc. It is to be noted that in some cases the image data referred to herein can include, in addition to images (e.g., captured images, processed images, etc.), numeric data associated with the images (e.g., metadata, hand-crafted attributes, etc.). It is further noted that images or image data can include data related to a processing step/layer of interest, or a plurality of processing steps/layers of a specimen.

It is appreciated that, unless specifically stated otherwise, certain features of the presently disclosed subject matter, which are described in the context of separate embodiments, can also be provided in combination in a single embodiment. Conversely, various features of the presently disclosed subject matter, which are described in the context of a single embodiment, can also be provided separately or in any suitable sub-combination. In the present detailed description, numerous specific details are set forth in order to provide a thorough understanding of the methods and apparatus.

It will also be understood that the system according to the present disclosure may be, at least partly, implemented on a suitably programmed computer. Likewise, the present disclosure contemplates a computer program being readable by a computer for executing the method of the present disclosure. The present disclosure further contemplates a non-transitory computer-readable memory tangibly embodying a program of instructions executable by the computer for executing the method of the present disclosure.

The present disclosure is capable of other embodiments and of being practiced and carried out in various ways. Hence, it is to be understood that the phraseology and terminology employed herein are for the purpose of description and should not be regarded as limiting. As such, those skilled in the art will appreciate that the conception upon which this disclosure is based may readily be utilized as a basis for designing other structures, methods, and systems for carrying out the several purposes of the presently disclosed subject matter.

Those skilled in the art will readily appreciate that various modifications and changes can be applied to the embodiments of the present disclosure as hereinbefore described without departing from its scope, defined in and by the appended claims.

1. A computerized system of examining a semiconductor specimen, the system comprising a processing circuitry configured to:
obtain an input image of the semiconductor specimen;
process the input image using a first machine learning (ML) model, to obtain a synthetic image corresponding to the input image, wherein the first ML model is previously trained for image reconstruction for a specific application, and the synthetic image is reconstructed to resemble a target image pertaining to the specific application;
process, by a second ML model, the synthetic image and one of the input image or the target image of the synthetic image, to obtain a defect map indicative of defect distribution in the input image or the target image with respect to the synthetic image, wherein the second ML model is previously trained for defect detection; and
verify quality of the synthetic image based on the defect map.

2. The computerized system according to claim 1, wherein the processing circuitry is configured to verify the quality of the synthetic image by comparing the defect map with ground truth defect information of the input image or the target image, and verifying, based on the comparison, whether an unexpected defect is present in the synthetic image during image reconstruction.

3. The computerized system according to claim 2, wherein the processing circuitry is further configured to provide a verification result indicative of presence of the unexpected defect in the synthetic image, use the verification result to prepare a refined training set, and retrain the first ML model using the refined training set.

4. The computerized system according to claim 2, wherein the ground truth defect information is obtained based on manual annotation, or a defect detection algorithm.

5. The computerized system according to claim 2, wherein the unexpected defect represents one of: an original defect in the input image that was supposed to be removed during image reconstruction, or an artificial defect that was introduced during image reconstruction.

6. The computerized system according to claim 1, wherein the specific application is reference generation, where the input image is an original image of the semiconductor specimen acquired by an examination tool, and the synthetic image is a reconstructed reference image that is expected to be defect-free and usable for comparison with the original image; and
wherein the processing circuitry is configured to process, by the second ML model, the synthetic image and the input image, to obtain a defect map indicative of defect distribution in the input image with respect to the synthetic image.

7. The computerized system according to claim 1, wherein the specific application is image enhancement, where the input image is a low-quality image of the semiconductor specimen, the synthetic image is a reconstructed high-quality image usable for examining the semiconductor specimen instead of using the low-quality image, and the target image is an actual high-quality image acquired by an examination tool; and
wherein the processing circuitry is configured to process, by the second ML model, the synthetic image and the target image, to obtain a defect map indicative of defect distribution in the target image with respect to the synthetic image.

8. The computerized system according to claim 1, wherein the specific application is image simulation, where the input image is a design image of the semiconductor specimen, and the synthetic image is a simulated image resembling the target image which is an actual image of the specimen acquired by an examination tool; and
wherein the processing circuitry is configured to process, by the second ML model, the synthetic image and the target image, to obtain a defect map indicative of defect distribution in the target image with respect to the synthetic image.

9. The computerized system according to claim 1, wherein the first ML model is previously trained under supervised learning using a training set comprising one or more pairs of training images, each pair including a training image and a corresponding ground truth image with respect to the specific application.

10. The computerized system according to claim 1, wherein the second ML model is previously trained using a training set comprising one or more pairs of training images, each pair including an input training image and a corresponding reference image, the input training image associated with ground truth defect information thereof.

11. The computerized system according to claim 10, wherein the second ML model is trained prior to, or together with, training of the first ML model, comprising: for each input training image in the training set, processing the input training image by the second ML model to obtain a predicted defect map, and optimizing the second ML model using a loss function to minimize a difference between the predicted defect map and the ground truth defect information of the input training image.

12. A computerized method of examining a semiconductor specimen, the method comprising:
obtaining an input image of the semiconductor specimen;
processing the input image using a first machine learning (ML) model, to obtain a synthetic image corresponding to the input image, wherein the first ML model is previously trained for image reconstruction for a specific application, and the synthetic image is reconstructed to resemble a target image pertaining to the specific application;
processing, by a second ML model, the synthetic image and one of the input image or the target image of the synthetic image, to obtain a defect map indicative of defect distribution in the input image or the target image with respect to the synthetic image, wherein the second ML model is previously trained for defect detection; and
verifying quality of the synthetic image based on the defect map.

13. The computerized method according to claim 12, wherein the verifying comprises comparing the defect map with ground truth defect information of the input image or the target image, and verifying, based on the comparison, whether an unexpected defect is present in the synthetic image during image reconstruction.

14. The computerized method according to claim 13, further comprising providing a verification result indicative of presence of the unexpected defect in the synthetic image, using the verification result to prepare a refined training set, and retraining the first ML model using the refined training set.

15. The computerized method according to claim 12, wherein the specific application is reference generation, where the input image is an original image of the semiconductor specimen acquired by an examination tool, and the synthetic image is a reconstructed reference image that is expected to be defect-free and usable for comparison with the original image; and
wherein the processing by the second ML model comprises processing the synthetic image and the input image to obtain a defect map indicative of defect distribution in the input image with respect to the synthetic image.

16. The computerized method according to claim 12, wherein the specific application is image enhancement, where the input image is a low-quality image of the semiconductor specimen, the synthetic image is a reconstructed high-quality image usable for examining the semiconductor specimen instead of using the low-quality image, and the target image is an actual high-quality image acquired by an examination tool; and
wherein the processing by the second ML model comprises processing the synthetic image and the target image to obtain a defect map indicative of defect distribution in the target image with respect to the synthetic image.

17. The computerized method according to claim 12, wherein the specific application is image simulation, where the input image is a design image of the semiconductor specimen, and the synthetic image is a simulated image resembling the target image which is an actual image of the specimen acquired by an examination tool; and
wherein the processing by the second ML model comprises processing the synthetic image and the target image to obtain a defect map indicative of defect distribution in the target image with respect to the synthetic image.

18. The computerized method according to claim 12, wherein the second ML model is previously trained using a training set comprising one or more pairs of training images, each pair including an input training image and a corresponding reference image, the input training image associated with ground truth defect information thereof.

19. The computerized method according to claim 18, wherein the second ML model is trained prior to, or together with, training of the first ML model, comprising: for each input training image in the training set, processing the input training image by the second ML model to obtain a predicted defect map, and optimizing the second ML model using a loss function to minimize a difference between the predicted defect map and the ground truth defect information of the input training image.

20. A non-transitory computer readable storage medium tangibly embodying a program of instructions that, when executed by a computer, cause the computer to perform a method of examining a semiconductor specimen, the method comprising:
obtaining an input image of the semiconductor specimen;
processing the input image using a first machine learning (ML) model, to obtain a synthetic image corresponding to the input image, wherein the first ML model is previously trained for image reconstruction for a specific application, and the synthetic image is reconstructed to resemble a target image pertaining to the specific application;
processing, by a second ML model, the synthetic image and one of the input image or the target image of the synthetic image, to obtain a defect map indicative of defect distribution in the input image or the target image with respect to the synthetic image, wherein the second ML model is previously trained for defect detection; and
verifying quality of the synthetic image based on the defect map.
